(19) United States
(12) Patent Application Publication
(10) Pub. No.: US 2020/0297559 A1
(43) Pub. Date: Sep. 24, 2020

(54) MEDICAL STRETCHER TRANSFER SYSTEM

(71) Applicant: NOVA PROFESSIONAL SERVICES PTY LTD, Mile End South (AU)

(72) Inventors: Aaron BARCLAY, Newstead (AU); Andrew James MOORE, Newstead (AU)

(73) Assignee: Nova Professional Services Pty Ltd, Mile End South (AU)

(21) Appl. No.: 15/779,718

(22) PCT Filed: Dec. 13, 2016
(86) PCT No.: PCT/AU2016/051226

§ 371 Date: May 29, 2018

(30) Foreign Application Priority Data
Dec. 17, 2015 (AU) 2015905228
Apr. 28, 2016 (AU) 2016901556

(51) Int. Cl. A61G 3/08; A61G 3/00; A61G 1/044; B60N 2/015; B64D 11/06

(52) U.S. Cl. CPC A61G 3/0875; A61G 3/001; B64D 11/0696; B60N 2/01516; A61G 1/044

(57) ABSTRACT

An apparatus for reversibly fixing a medical apparatus to a vehicle, the apparatus comprising a fitting to engage with the vehicle, and a support wherein the support comprises means for reversible engagement with a medical apparatus and the arrangement of the fitting relative to the support is adjustable so as to enable reversible fixing of the apparatus to a plurality of vehicle configurations.

### CROSS-REFERENCE TO RELATED APPLICATIONS

The present patent application is a National stage patent application from PCT application PCT/AU2016/051226 filed on Dec. 13, 2016 claiming priority to Australian patent applications AU 2015905228 filed Dec. 17, 2015 and AU 2016901556 filed Apr. 28, 2016.

### BACKGROUND OF THE INVENTION

Typically, an aeromedical evacuation system includes an aeromedical stretcher mounted on a dedicated medical floor or a stretcher base. The medical floor or stretcher base is installed onto the aircraft cabin floor. The patient is placed onto the stretcher which is then carried into the aircraft. The life support equipment is then connected to the patient to support the patient throughout the air transfer. Upon the aircraft landing, the life support equipment is disconnected and the patient is unloaded from the aircraft whilst remaining on the patient stretcher. In mixed modal aeromedical transfers where the patient is transferred from a helicopter to an aeroplane (or vice versa), patients are often transferred from one stretcher to another due to incompatibility between the stretcher systems on the different aircraft types. The life support equipment is also removed during transfers between the different aircraft. This creates points of risk to the patient.

Typically aeromedical stretchers do not have any attachments on the stretcher to mount life support or other equipment. Instead, life support equipment is usually mounted on fixed locations in the aircraft cabin. They are usually either connected to the patient only after the patient has been loaded onto the aircraft or removed from the cabin mountings and hand carried to the patient, being connected to the patient while the patient is loaded onto the stretcher. The life support equipment are either hand carried or stacked on top of the patient while the patient is being loaded into the aircraft (such as a helicopter or fixed wing aircraft) and then mounted onto the fixed cabin mounts for the duration of the flight. When the patient is unloaded from the aircraft, the life support equipment must then be disconnected from the patient or, if they are to remain connected, the equipment must be removed from the fixed mounts in the cabin and hand carried by medical personnel while the patient is moved from the aircraft into the ambulance or hospital emergency room. Such prior art stretchers do not have a secure way of mounting the life support equipment on the stretcher and ensuring that the medical risks of repeated life support equipment connection/disconnection are minimized during helicopter aeromedical transfers.

Such prior art stretchers are secured in the aircraft using aircraft specific medical floor or stretcher bases which locks the stretcher in place during flight. The medical floor, stretcher bases and locking mechanisms are not interchangeable between different aircraft types due to incompatible fastening systems or different cabin configurations.

The lack of interchangeability between the medical floor or stretcher bases limits the use of such prior art stretchers to specific aircraft types and models only, and the same equipment cannot be used on other aircraft types in field service. This also often requires permanent modifications to be made on the aircraft to accommodate aeromedical evacuation equipment installation, reducing the flexibility of using any available aircraft for aeromedical evacuation missions.

The reference to any prior art in this specification is not, and should not be taken as, an acknowledgement or any form of suggestion that the prior art forms part of the common general knowledge.

### SUMMARY OF THE INVENTION

In one aspect of the invention, there is provided an apparatus for reversibly fixing a medical apparatus to a vehicle, the apparatus comprising a fitting to engage with the vehicle, and a support wherein the support comprises means for reversible engagement with a medical apparatus and the arrangement of the fitting relative to the support is adjustable so as to enable reversible fixing of the apparatus to a plurality of vehicle configurations.

The apparatus of the invention may be used to reversibly fix any type of medical apparatus which may be required to be fixed to a vehicle. In some preferred embodiments, the apparatus of the invention is used to reversibly fix a patient carrying device, such as a stretcher or a litter and/or associated medical equipment in the interior of a vehicle such as an ambulance, an aircraft, a water craft, etc. However, it is quite possible that the apparatus may be used in other situations, such as to fix medical apparatus to the exterior of a vehicle or to fix other medical apparatus.

The term ‘fixing’ as used herein is intended to convey that once fixed, the apparatus is held in a fixed position relative to the vehicle so that it may be safely transported by the vehicle.

Reversible fixing, therefore means that although the item is held fixed, this state can be reversed or altered so as to allow removal or adjustment of the relative position of the item as compared to the vehicle.

The fitting for engagement with the vehicle can be of any suitable type. It may comprise bolts, pins, clamps, or any other suitable fixing element. In some preferred embodiments it comprises a seat track fittings that fits into seat tracks mounted on the floor of the vehicle. In some preferred embodiments of the invention, there is provided a mount comprising at least one fitting according to the invention. In some embodiments, such a mount comprises a plurality of such fittings arranged and/or adjustable so as to engage with part of the vehicle. As an example, in some embodiments, there is provided a mount comprising a plurality of seat track fittings arranged so as to engage with a seat track. Some preferred embodiments also comprise a locking mechanism to hold a mount according to the invention in a fixed position relative to the vehicle.

A support according to the invention can be of any suitable type provided that it is designed to properly support the medical apparatus (and/or patient as the case may be) for the intended transportation in the vehicle. In some preferred embodiments, the support comprises at least one load bearing beam which in some embodiments is adjustably engaged with the fitting and/or the mount so as to enable reversible fixing of the apparatus to a plurality of vehicle configurations.

A support according to the invention is intended to be reversibly engaged with the medical apparatus to be transported. The means of such reversible engagement may be of any suitable type. It may be as simple as a series of straps or clamps, or it may comprise hole and pin arrangements, or bolts, or any other suitable locking mechanism. Preferred embodiments comprise a reversible engagement means that is quickly released so as to provide for fast deployment and/or removal of the apparatus as required. The skilled addressee will appreciate that reversible engagement with a medical apparatus may comprise such engagement with a structure or housing within or to which the actual medical apparatus is held or attached.

In another aspect of the invention, there is provided a guide for facilitating fixing of a medical apparatus to a vehicle comprising and fixing means to fix the guide to a surface of a vehicle and an inclined portion to guide the medical apparatus along a path directly away from the vehicle surface. In some preferred embodiments the guide comprises a ramp as described herein.

In another aspect, the invention provides a stretcher for transporting a patient comprising a body support element, a structural element and a reversible engagement element to reversibly and fixedly engage the stretcher with a vehicle, wherein the reversible engagement element is adjustable for ready engagement with a plurality of vehicle configurations.

In another aspect, the invention provides a medical equipment mount comprising a medical equipment support element, a structural element and a reversible engagement element to reversibly and fixedly engage the mount with a vehicle, wherein the reversible engagement element is adjustable for ready engagement with a plurality of vehicle configurations.

In another aspect of the invention, there is provided a medical containment tray comprising a reversible engagement element to reversibly and fixedly engage the tray with a vehicle, wherein the reversible engagement element is adjustable for ready engagement with a plurality of vehicle configurations.

In another aspect of the invention there is provided an apparatus for fixing a plurality of medical apparatuses to a vehicle comprising a vertical support upon which a lower mount and an upper mount may be installed.

In another aspect, there is provided a system for reversibly fixing a stretcher to a vehicle, the system comprising a reversible engagement element to reversibly and fixedly engage the stretcher with a vehicle, wherein the reversible engagement element is adjustable for ready engagement with a plurality of stretcher and vehicle configurations.

In another aspect of the invention there is provided a medical apparatus stand comprising a fixing mechanism to fix the stand in a stationary position, a support and a mount adapted for reversible fixing to a medical apparatus. The fixing mechanism may be of any suitable type and in some preferred embodiments it is capable of enabling the stand to be reversibly fixed to a stretcher and/or the floor of a vehicle. In some such embodiments, the fixing mechanism comprises a clamp to reversibly fix the stand in attachment to a stretcher. The support can be of any suitable type provided that it is capable of supporting the weight of the mount and the medical apparatus intended to be fixed to it. In some preferred embodiments it comprises one or more poles which for example may be adjustable. The mount may be of any suitable type provided that it is capable of supporting the intended medical apparatus. In some preferred embodiments the mount comprises a plurality of predefined fixing points for fixing a medical apparatus to the mount. Such predefined fixing points may be of any suitable type, for example, clamps, recesses, holes, slots, etc.

A body support element according to the invention may take any suitable form. In some preferred embodiments, it comprises a flat section on which a patient can lie. Some embodiments further comprise a portion of the body support element which may be raised or lowered for additional patient comfort or for other medical reasons.

A structural element according to the invention may be of any suitable type. In some preferred embodiments, it comprises a strong, but light weight frame to which the body support element is fixed.

A reversible engagement element according to the invention can be of any suitable form able to be adjusted for ready engagement with a plurality of stretcher and vehicle configurations. In some preferred embodiments, it comprises a series of structural elements which can be fitted together in a variety of ways so that corresponding engagement means can engage with a part of the vehicle in reversible, but fixed manner. In some embodiments, the reversible engagement comprises a series of structural elements which can be fitted together in a variety of ways so that the corresponding engagement means can engage different stretchers in a reversible, but fixed manner, while simultaneously engaging with a part of the vehicle in reversible, but fixed manner. This fixed engagement must be sufficient to ensure that the patient is kept safely restrained in concert with the vehicle. In some embodiments, the fixed engagement must also meet vehicular regulatory requirements, such as those for road vehicles, trains or aircraft, etc.

A particular feature of the invention is the ability to adjust the reversible engagement element during use so as to adapt it from one vehicle to another. A simple example of this may be in transferring a patient on the stretcher from an ambulance, to a helicopter, to a fixed-wing aircraft and then back to an ambulance. Each of these vehicles may have different on-vehicle fixing requirements.

Another feature of some aspects of the invention is the ability to adjust the reversible engagement element during use so as to adapt it from one stretcher type to another. A simple example of this may be the use of different types of stretchers. A simple example of this may be in the use of litters or other aviation stretchers in transferring the patient from an ambulance, to a helicopter, to a fixed-wing aircraft and then back to an ambulance. Each of these stretchers may have different fixing requirements and different on-vehicle fixing requirements.

In some embodiments there is provided an aeromedical evacuation system which comprises a stretcher system according to the invention that can be mounted in the aircraft cabin in north-south or east-west orientation, secured on the cabin floor using an interchangeable and configurable floor mounting mechanism that can be adapted in the field to the different aircraft cabin seat track fittings. The floor mounting mechanism is configurable to secure and lock the stretcher in place, or to secure and lock other aeromedical accessories in place, for example, oxygen bottle racks and medical storage cabinets.

In some embodiments there is provided an aeromedical evacuation system which comprises a stretcher system such as a litter, that can be mounted in the aircraft cabin in north-south or east-west orientation, secured on the cabin floor using an interchangeable and configurable floor mounting mechanism that can be adapted in the field to the types of stretchers and different aircraft cabin seat track or hard point fittings. The floor mounting mechanism is configurable to secure and lock the stretcher in place, or to secure and lock other aeromedical accessories in place, for example, oxygen bottle racks and medical storage cabinets.

A stretcher system according to the invention is also configurable with a stretcher bridge upon which life support equipment are mounted. The patient is loaded onto the stretcher at the point of medical evacuation, and the life support equipment connected to the patient. The entire stretcher and bridge assembly is designed to be loaded onto the aircraft as a complete assembly, and unloaded from the aircraft onto the hospital or road ambulance stretcher as a complete assembly, or loaded onto another aircraft for further transfer.

Whilst the invention is particularly suited to transporting human patients, it may equally be applicable to transporting veterinary patients which are required to be transported on a stretcher or similar apparatus.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS

### Brief Description of the Figures

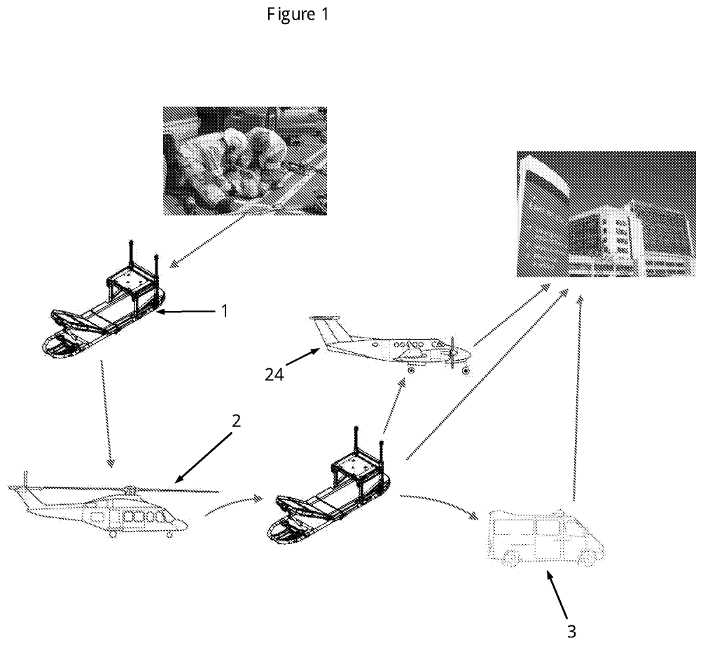

FIG. 1 illustrates a flow chart overview of an example use of a stretcher according to the invention.

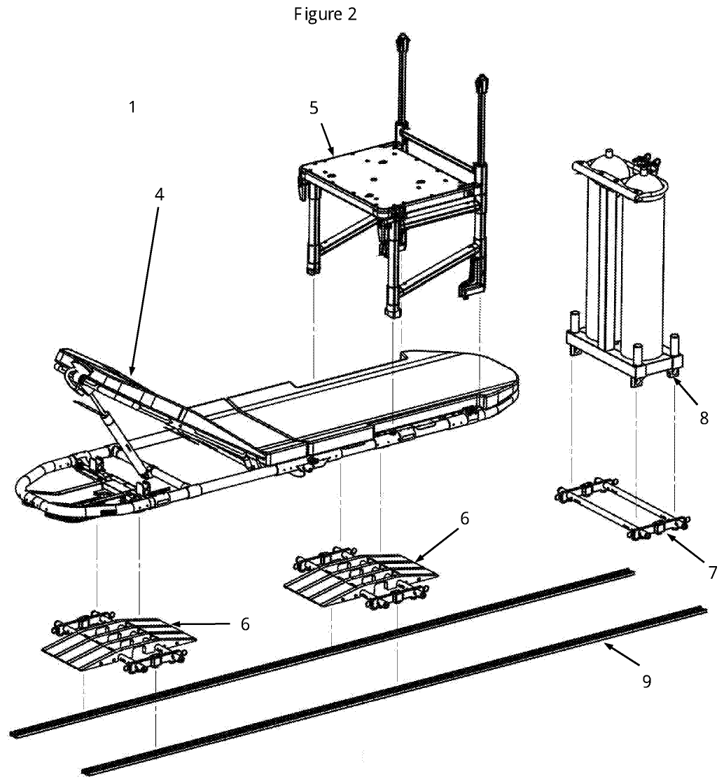

FIG. 2 is an isometric exploded view depicting example components of a stretcher system according to the invention.

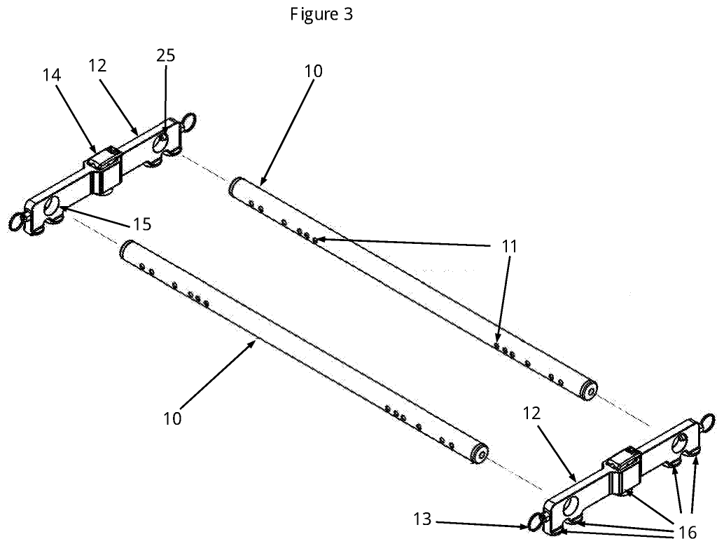

FIG. 3 is an isometric exploded view depicting an example interchangeable and reconfigurable floor mounting mechanism.

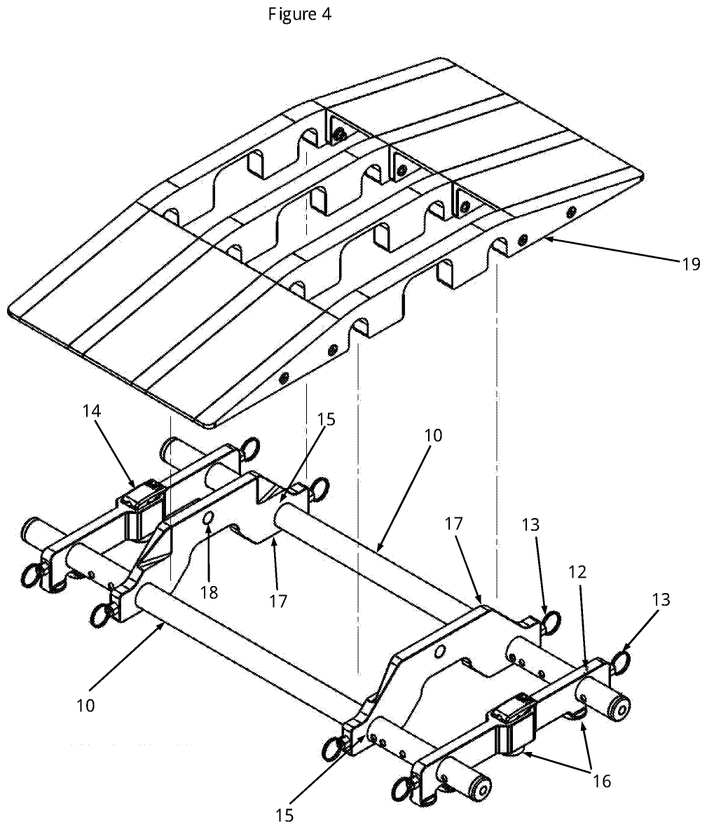

FIG. 4: is an isometric exploded view depicting an example interchangeable and reconfigurable floor mounting mechanism in an alternate stretcher mount configuration.

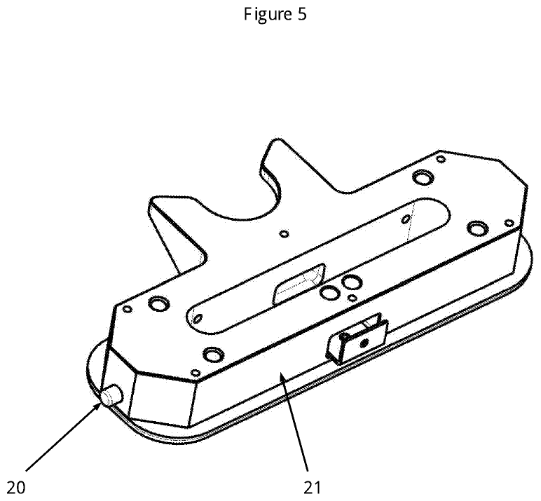

FIG. 5 depicts a perspective view of an example stretcher mount latch.

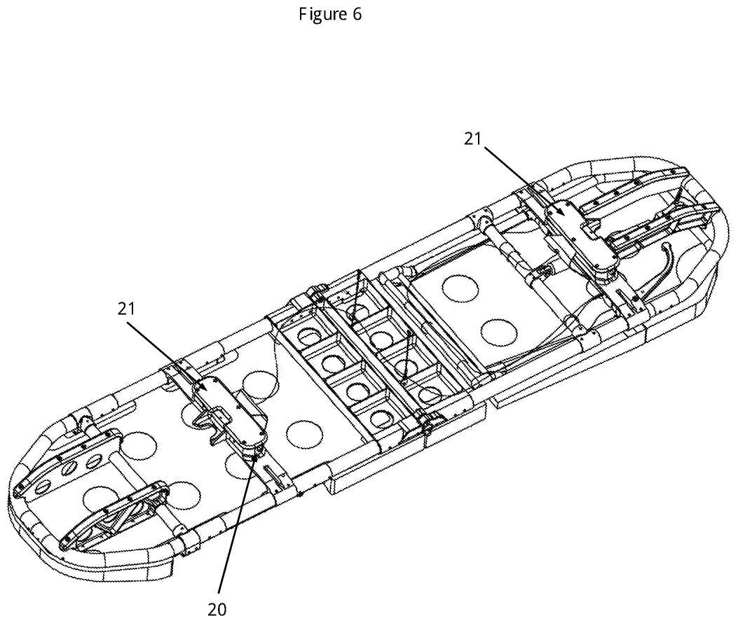

FIG. 6 depicts an example stretcher mount latch location on the underside of a stretcher according to the invention.

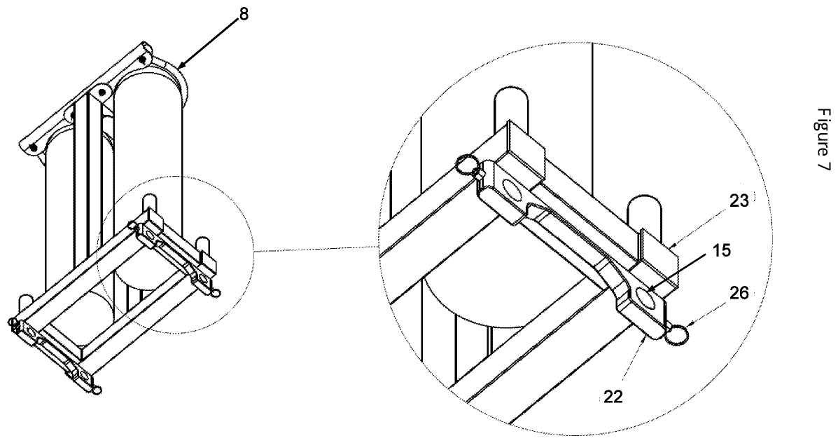

FIG. 7 depicts an example medical accessory mounting mechanism.

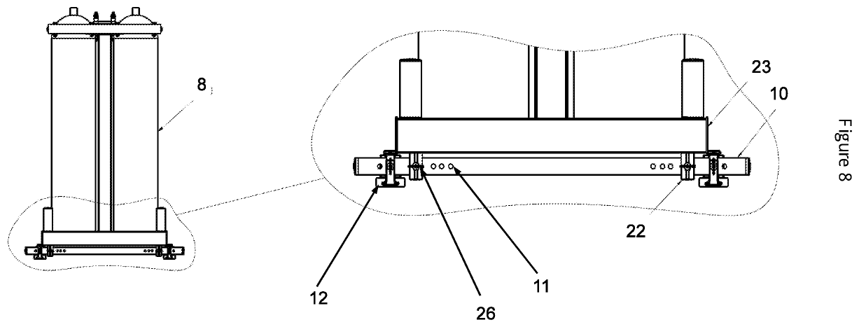

FIG. 8 depicts an example of how the medical accessory mounting mechanism is attached to the interchangeable and reconfigurable floor mounting mechanism.

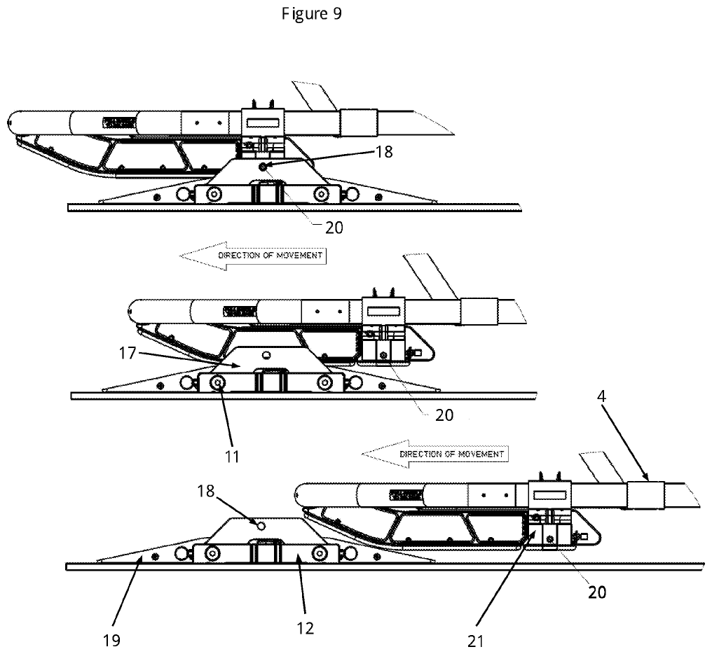

FIG. 9 depicts an exemplary stretcher glide ramp according to the invention.

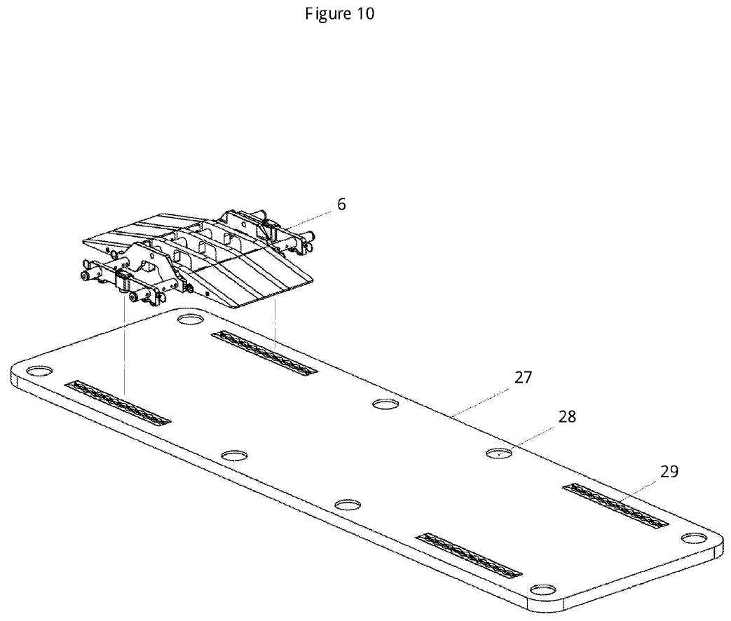

FIG. 10 depicts a generic example of a medical floor with seat tracks mounted on it.

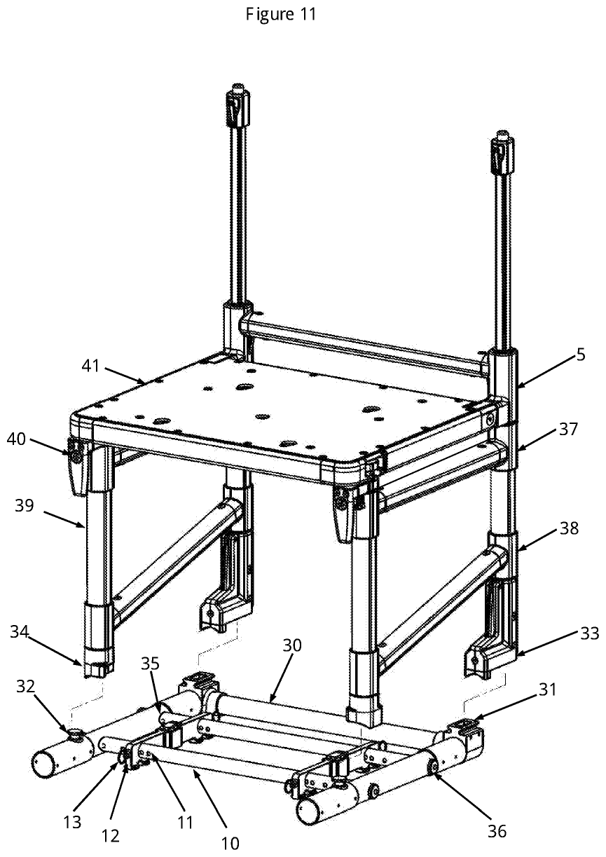

FIG. 11 depicts a generic example of mounting medical accessory.

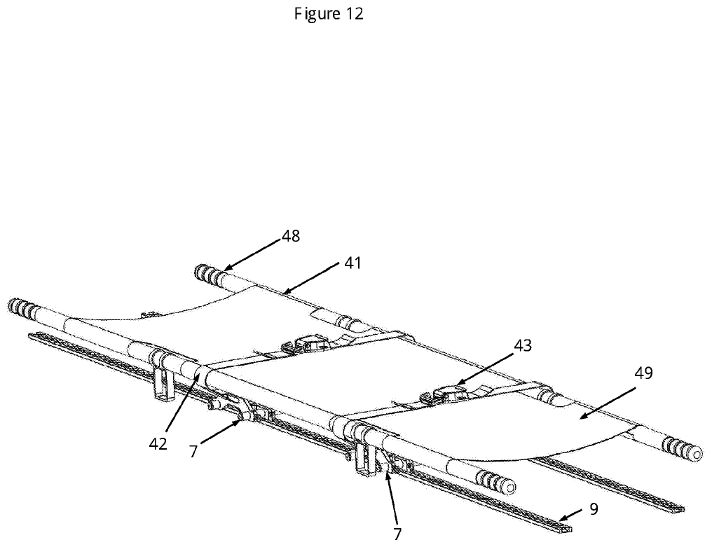

FIG. 12 depicts an example stretcher mount securing a litter to the floor mounting mechanism in an alternate stretcher mount configuration using only cross body straps.

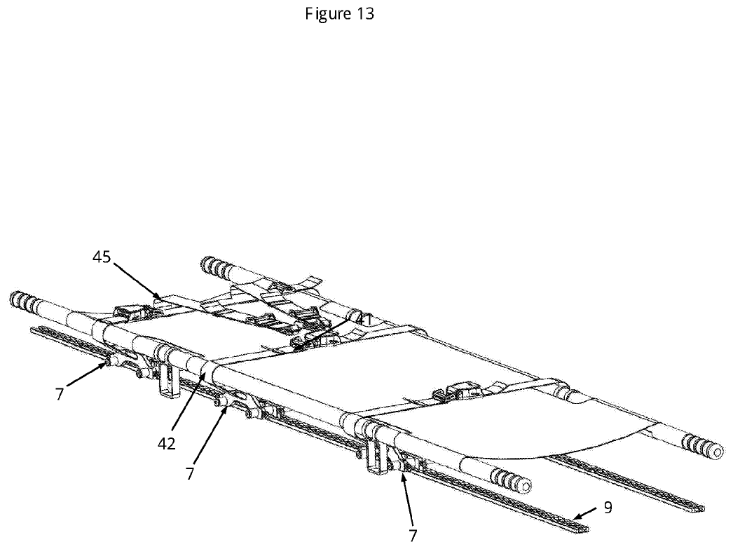

FIG. 13 depicts an example stretcher mount securing a litter to the floor mounting mechanism in an alternate stretcher mount configuration using cross body straps and a shoulder harness.

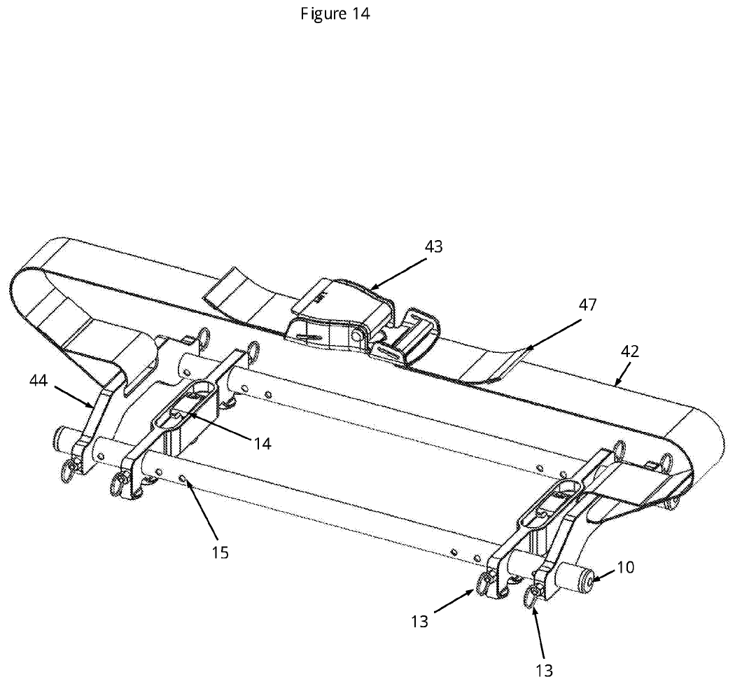

FIG. 14 depicts an example interchangeable and reconfigurable floor mounting mechanism in an alternate litter mount configuration with cross body straps.

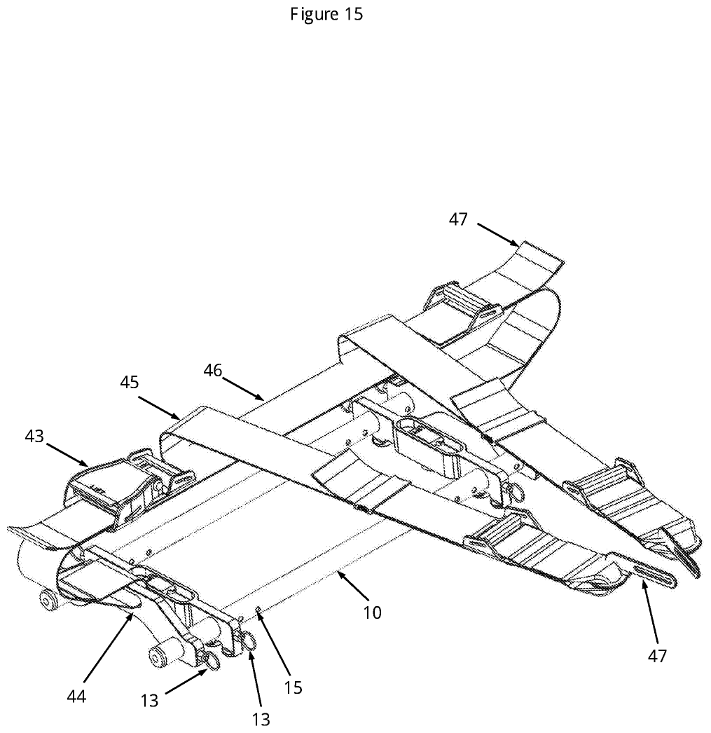

FIG. 15 depicts an example interchangeable and reconfigurable floor mounting mechanism in an alternate litter mount configuration with shoulder harness.

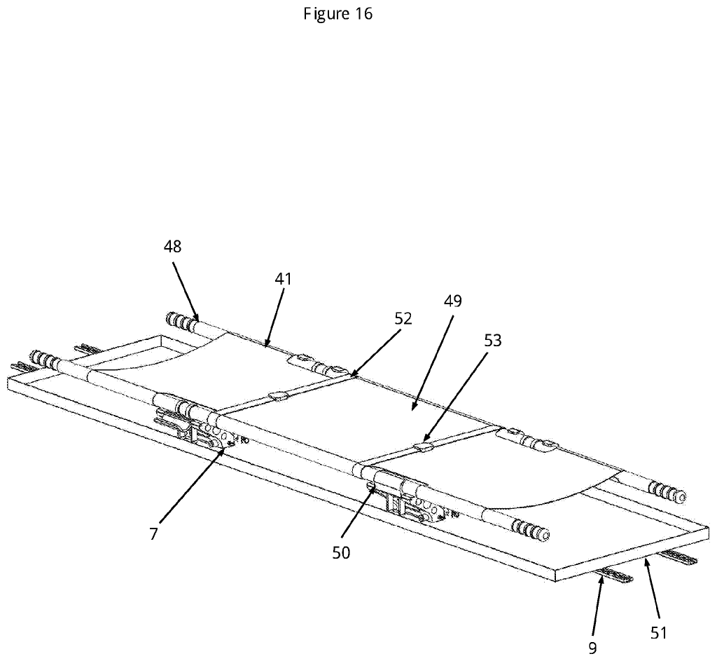

FIG. 16 depicts an example stretcher mount securing a litter to the floor mounting mechanism in an alternate stretcher mount configuration using mechanical securing means.

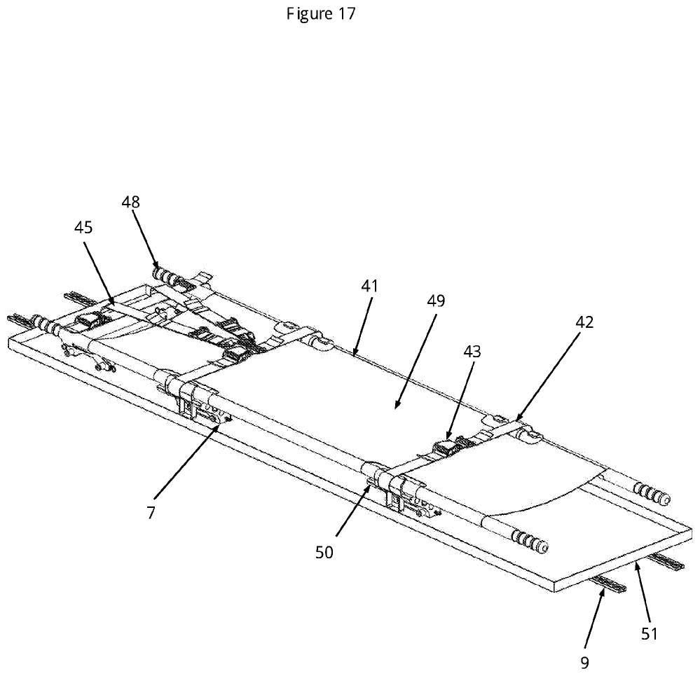

FIG. 17 depicts an example stretcher mount securing a litter to the floor mounting mechanism in an alternate stretcher mount configuration using mechanical securing means and configured with cross body straps and a shoulder harness, with an optional containment tray accessory mounted under the litter.

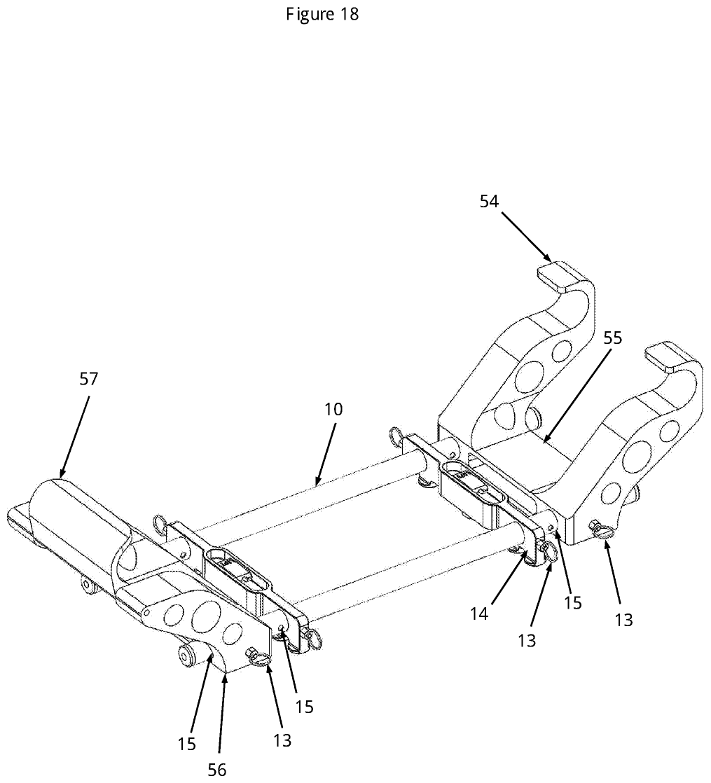

FIG. 18 depicts an example interchangeable and reconfigurable floor mounting mechanism configured with a mechanical litter securing mount according to the invention.

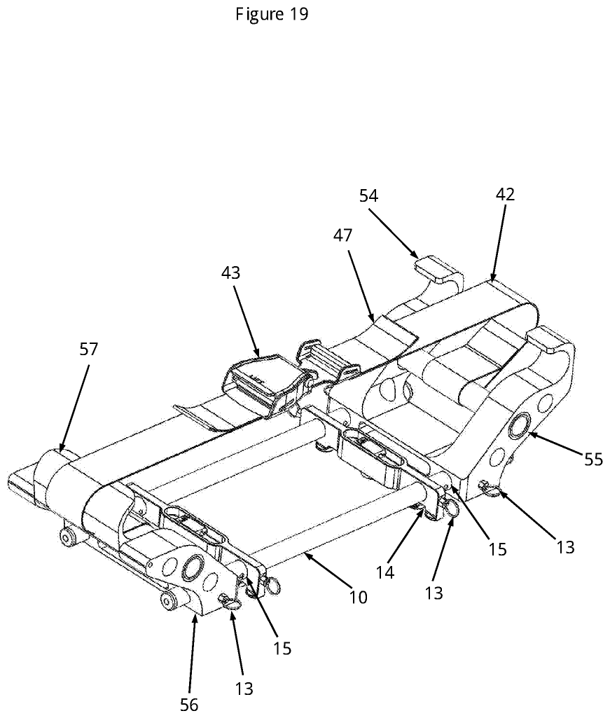

FIG. 19 depicts an example interchangeable and reconfigurable floor mounting mechanism configured with a mechanical litter securing mount according to the invention, and a cross body strap.

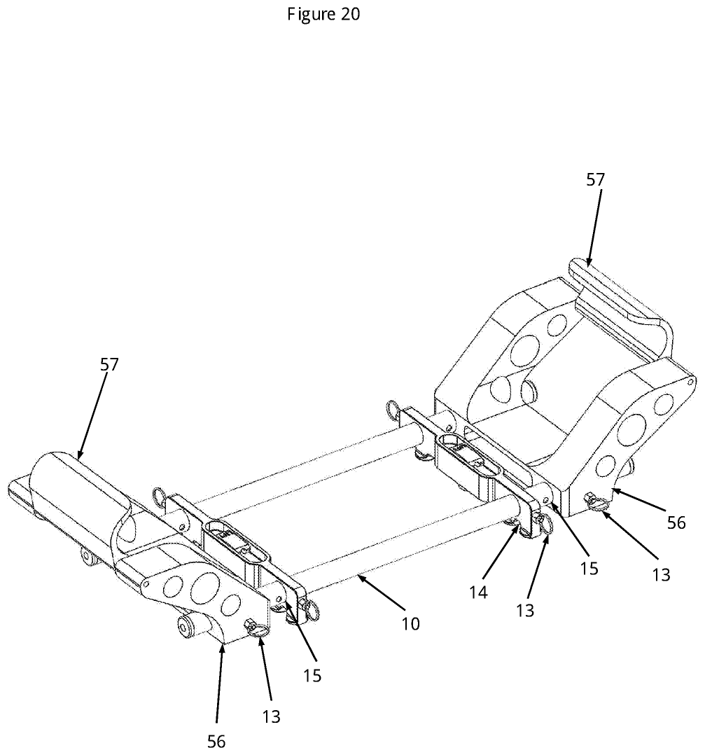

FIG. 20 depicts another an example interchangeable and reconfigurable floor mounting mechanism.

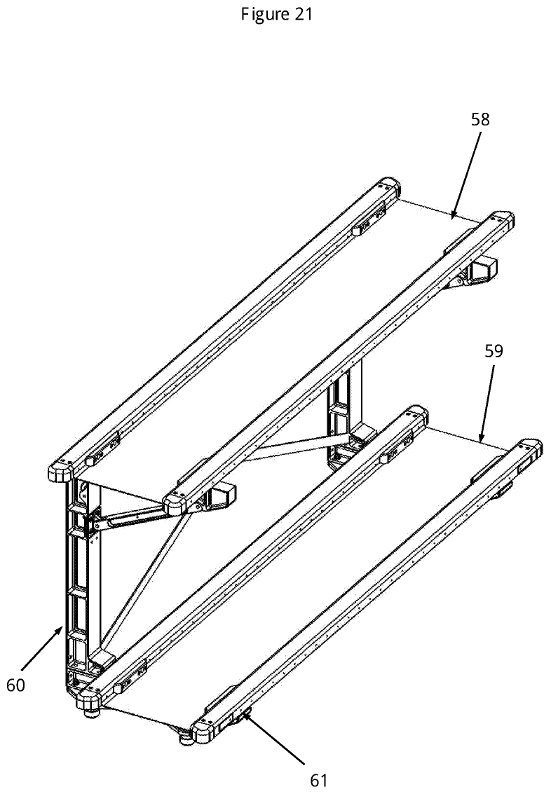

FIG. 21 depicts a generic example dual stretcher mount typifying an accessory that may be configured as part of the medical stretcher transfer system.

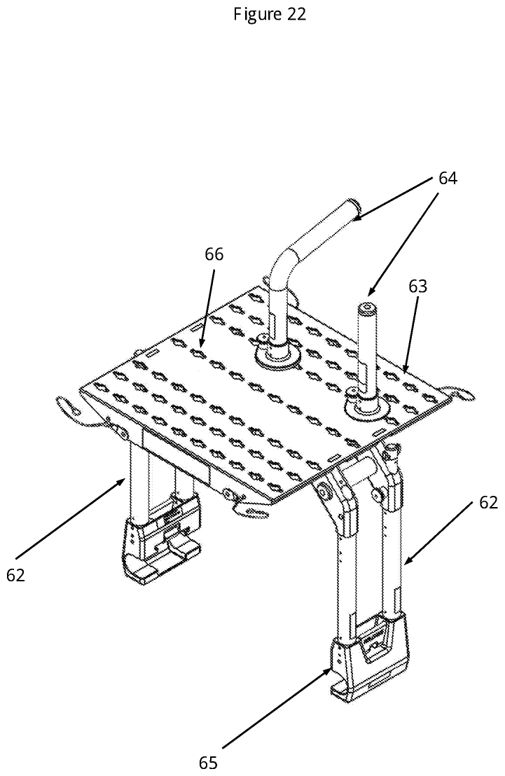

FIG. 22 depicts an alternative implementation of a stretcher bridge according to the invention.

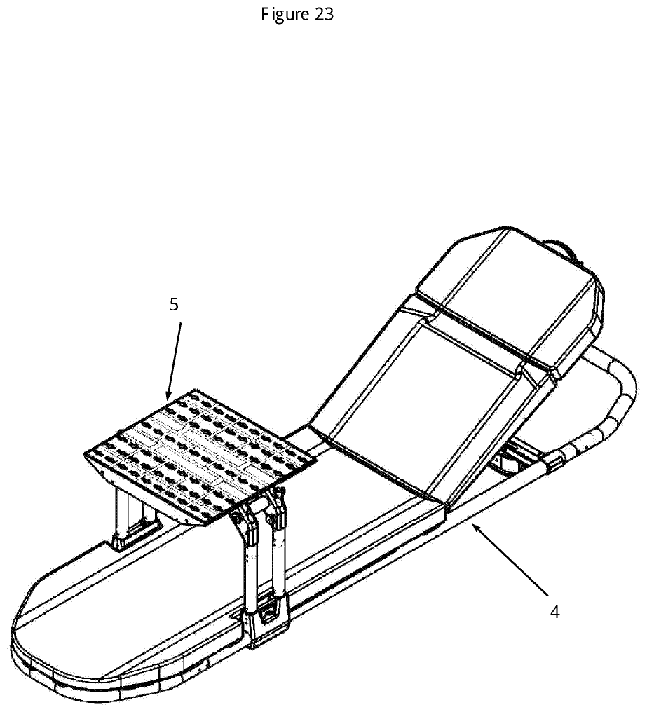

FIG. 23 depicts an example implementation scheme to secure a stretcher bridge.

### DETAILED DESCRIPTION OF THE PREFERRED EMBODIMENT

### Detailed Description of Exemplary Embodiments

As set out above, FIG. 1 is a flow chart which illustrates an overview of an example use of a stretcher according to the invention. This Figure depicts the single transfer concept of keeping the life support equipment attached and connected throughout the aeromedical transfer process until the patient arrives at the treatment facility.

At the top left of the flow chart the patient is treated on scene and loaded onto a stretcher system (1) with life support equipment fitted on the stretcher bridge. The patient and stretcher with life support equipment is then loaded onto a helicopter (2) for transport. On arrival at the helipad, the patient is unloaded on the stretcher system onto a hospital or ambulance stretcher as a whole while still connected to the life support equipment. If the hospital does not have a helipad, the ambulance (3) transfers the patient on the stretcher system to the treatment facility. Only on arrival at the treatment facility, is the patient disconnected from the life support system mounted on the stretcher system and immediately connected to the life support system at the treatment facility. In some instances, a patient may need to be transferred from a helicopter (2) to a fixed wing aircraft (24), but again remains on the same stretcher system throughout.

FIG. 2 is an isometric exploded view depicting example components of a stretcher system according to the invention. This Figure depicts important elements and components that make up an aeromedical evacuation system according to the invention.

The aeromedical evacuation system according to the invention shown generally at (1) consists of an aviation stretcher (4) with a stretcher bridge (5) for mounting life support equipment, interchangeable and reconfigurable floor mounting mechanism (7) that can be user configured into alternate configurations (6), and aeromedical evacuation accessories (8) of which the depicted is an example of and is illustrative only. The interchangeable floor mounting mechanism (7) and its alternate configurations (6) are installed onto the aircraft cabin or medical floor (27) (FIG. 10) mounted seat tracks (9).

In this description, aircraft (2) and (24), although depicted as a helicopter and aeroplane respectively, may be either a helicopter or aeroplane or any other aircraft or vehicle used to transport a patient. In some preferred embodiments, the invention may be used for water-based rescue and the stretcher system of the invention may be fitted to land based medical transport vehicles such as ambulances. The depiction in FIG. 1 is illustrative only.

The stretcher system according to the invention is designed for the patient to be loaded onto the stretcher (4) and the life support equipment mounted on the stretcher bridge (5) to be connected to the patient. The entire unit (4), (5) and (6) to be loaded into the aircraft (2) and secured onto the aircraft cabin floor or medical floor (27) installed in the aircraft cabin using the interchangeable and reconfigurable floor mounting mechanism (7) in the stretcher mount configuration (6). Medical equipment (such as life support equipment) installed on the stretcher bridge (5) remain attached and connected to the patient throughout the flight.

Upon the aircraft (2) landing, the patient is unloaded from the aircraft (2) while remaining on the stretcher system according to the invention (4) and (5). The entire stretcher unit (4) and (5) are either transferred onto another aircraft (24), onto an ambulance (3) or directly into the treatment facility where the patient is transferred off the stretcher system according to the invention (4) and (5) for treatment. This invention eliminates the need to disconnect life support systems during transfer, allowing the life support equipment to remain connected to the patient throughout. This invention also provides a secure method of mounting and keeping the life support equipment attached to the stretcher throughout the entire transfer process until the patient reaches the treatment facility, and solving the problem of having to dismount life support equipment from fixed mounting locations in the cabin and medical personnel hand carrying the equipment when the patient is unloaded from the aircraft (2) and loaded into another aircraft (24) or ambulance (3).

In some embodiments of the invention there is provided a compartment or plinth underneath the stretcher. The medical equipment including life support systems are mounted in the compartment to provide better access to the lower part of the patient without the stretcher bridge (5) getting in the way of accessing the lower limbs.

In some embodiments, the stretcher bridge (5), has legs that can be opened up to enable access to the lower limbs of the patient. This is exemplified in FIG. 11. The forward legs can be unlocked at the forward attachment (34) which attaches to the stretcher (4) and the forward leg locking latch (40) which attaches the upper part of the forward legs to the medical bridge platform (41). The lower leg assembly (39) can then swing outwards, pivoting around the upper leg hinge (37) and the lower leg hinge (38). By unlatching and swinging the lower leg assembly outwards, the patient's lower limbs may be accessed for treatment without the bridge getting in the way.

FIG. 3 is an isometric exploded view depicting an example interchangeable and reconfigurable floor mounting mechanism. The basic configuration of the floor mounting mechanism (7) comprises of two load bearing beams (10) equipped with load beam mounting holes (11) at varying distances and two seat track mounts (12). The ends of the load bearing beams (10) are inserted into the load beam mounting holes (15) in the seat track mounts (12). The seat track mount (12) has a spring loaded pin (13) on each side, with pins that protrude into the load beam mounting holes (15). The spring loaded pin (13) may be retracted from the load beam mounting holes (15) by pulling on the ring mounted on its end to compress the internal spring. The spring loaded pin (13) extends into one of the load beam mounting holes (11) to secure the load bearing beams (10) in place. By varying the load beam mounting holes (15) that the spring loaded pin (13) is inserted into, the seat track mounts (12) may be adjusted along the length of the load bearing beam (10) to accommodate different pitch adjustments and seat track (9) widths. The seat track mount (12) is equipped with several seat track fittings (16) that fit into seat tracks mounted on the aircraft cabin floor or medical floor (27). The seat track fittings (16) may be specific to the seat track types. The seat track mount (12) is equipped with a seat track lock (14) that when latched, securely locks the seat track mount (12) onto the seat track (9). Once the two seat track mounts (12) are locked onto the seat track (9), the interchangeable and reconfigurable floor mounting mechanism (7) is securely locked onto the aircraft cabin floor or medical floor (27) mounted on the aircraft cabin floor.

By changing the type of seat track fittings (16) on the seat track mount (12), and adjusting the location of the seat track mounts (12) along the load bearing beams (10), the interchangeable and reconfigurable floor mounting mechanism (7) can be adapted to different aircraft types equipped with different configurations of seat tracks (9). For aircraft that have unusual seat tracks (9), seat track mount (12) with matching seat track fittings (16) may be used; or as depicted in FIG. 10, a medical floor (27) with seat tracks (29) installed on it may be fitted on top of the aircraft cabin floor, secured in place by seat track fittings specific to the seat track type with the seat track fittings mounted through the floor attachment holes (28) on the medical floor (27), For aircraft that have no seat track fittings but mounting points instead, the medical floor (27) may be installed and secured to the aircraft cabin floor mounting points by threading attachment points through the medical floor attachment holes (28).

FIG. 10 is a depiction of a generic medical floor (27) with seat tracks (29) fitted. The interchangeable and reconfigurable floor mounting system in the alternate stretcher configuration (6) is mounted on the medical floor (27) seat tracks (29). The floor attachment holes (28) on the medical floor (27) allow the medical floor (27) attachment bolts to be attached to the underlying aircraft cabin's unique seat tracks (9) or mounting points. An interchangeable and reconfigurable floor mounting mechanism (7) according to the invention is designed to be installed rapidly after removal of the seats to make room for the stretcher system according to the invention. The aircraft seats are usually easily removable as part of the aircraft cabin reconfiguration process.

FIG. 4: is an isometric exploded view depicting an example interchangeable and reconfigurable floor mounting mechanism in an alternate stretcher mount configuration. The basic interchangeable and reconfigurable floor mounting mechanism (7) may be reconfigured into an alternate stretcher mount configuration (6). This is done for example through the addition of two stretcher mounts (17) and a stretcher glide ramp (19). The stretcher mount (17) has two load beam mounting holes (15) similar to the seat track mounts (12) through which the load beams are passed. The stretcher mount (17) has a spring loaded pin (13) on each side, with the end of the pins (25) that protrudes into the load beam mounting holes (15). The spring loaded pin (13) may be retracted from the load beam mounting holes (15) by pulling on the ring mounted on its end to compress the internal spring. The end (25) of the spring loaded pin (13) extends into one of the load beam mounting holes (11) to secure the stretcher mount (17) in place along the load bearing beams (10).

As depicted in FIGS. 4 and 5, the stretcher mount has a stretcher mounting pin hole (18) where the retractable stretcher mounting pin (20) on the stretcher mounted stretcher mount latch (21) may be inserted to securely lock the stretcher onto the stretcher mount (17). The stretcher glide ramp (19) is mounted over the load bearing beams (10) to provide a smooth glide surface for the stretcher to slide along until it can be latched in place on the stretcher mount (17) and the retractable stretcher mount pin (20) is extended to engage with the stretcher mount pin hole (18).

FIG. 9 demonstrates the stretcher mounting process in action. Starting from the lower right diagram in FIG. 9, as the stretcher (4) is pushed towards the left in the direction of movement as indicated in the arrows, the stretcher (4) will be pushed up the stretcher glide ramp (19) until it crests the stretcher glide ramp (19) as indicated by the diagram in the middle of FIG. 9. As the stretcher (4) is pushed further to the left the stretcher mount pin (20) is retracted first to slide the stretcher in place, and then extended to engage the stretcher mount pin hole (18) and lock the stretcher (4) in place, as depicted by the top diagram in FIG. 9.

Returning to FIG. 4, an alternate stretcher mounting process in lieu of using the stretcher glide ramp (19) is to position the stretcher (4) with the stretcher mount latch (21) directly above the stretcher mount pin hole (18), and then lowering the stretcher (4) vertically while retracting the stretcher mount pin (20) until the stretcher mount pin (20) is aligned with the stretcher mount pin hole (18). The stretcher mount pin (20) is then extended to engage the stretcher mount pin hole (18).

FIG. 5 depicts a perspective view of an example stretcher mount latch and FIG. 6 depicts an example stretcher mount latch location on the underside of a stretcher. The stretcher mount latch (21) is mounted on the underside of the stretcher (4), of which two stretcher mount latches will be attached. The underside of the stretcher mount latch (21) provides a glide surface that allows the stretcher (4) to slide up the stretcher glide ramp (19) into position for the stretcher mounting pin (20) to engage the stretching mounting pin hole (18). FIG. 5 shows an example stretcher latch mechanism embodying the stretcher mounting pin (20). FIG. 9 it demonstrates the stretcher mounting pin (20) in operation. The underside of the stretch mount latch (21) provides a glide surface as the stretcher (4) crests the stretcher glide ramp (19) and the stretcher mount pin (20) is aligned at the same height as the stretcher mount pin hole (18) and engages to lock the stretcher (4) in place.

An alternative mounting mechanism which is considered part of the stretcher mount latch (21), stretcher mounting pin (20) and stretcher mount pin hole (18) is the use of a fixed stretcher mount pin (20) that engages with a notch, latch or clamp instead of a stretcher mount pin hole (18)

FIG. 7 depicts an example medical accessory mounting mechanism viewed from the underside. The medical accessory depicted in FIG. 7 is an oxygen bottle storage rack and is a generic depiction illustrating the concept of the mounting mechanism. The medical accessory may include oxygen bottle racks, storage cabinets, medical equipment, or the stretcher bridge (5), or any device or equipment for which mounting would assist. The interchangeable and reconfiguration floor mounting mechanism (7) may be reconfigured to mount any suitable medical accessories (8). The medical accessory (8) is equipped with a mounting frame (23). The mounting frame (23) is equipped with two accessory floor mounts (22). Each accessory floor mount (22) has a spring loaded pin (26) on each side, with pins that protrudes into the load beam mounting holes (15). The spring loaded pin (26) may be retracted from the load beam mounting holes (15) by pulling on the ring mounted on its end to compress the internal spring. The spring loaded pin (26) extends into one of the load beam mounting holes (11) to secure the accessory floor mount (17) in place along the load bearing beams (10). This secures the medical accessory mounting mechanism onto the interchangeable and reconfiguration floor mounting mechanism, which is in turn mounted on the cabin floor seat tracks (9).

FIG. 8 depicts a side view of the medical accessory mounting system. The medical accessory mounting frame (23) has two accessory floor mounts (22) with load beam mounting holes (15) that the load bearing beams (10) are inserted through. The accessory floor mounts (22) are located inside the seat track mount (12).

FIG. 10 depicts an example of a medical floor with seat tracks mounted on it. In some situations a medical floor such as this may be used as a proxy surface for the stretcher to be mounted and secured, and the medical floor is in turn mounted on the aircraft cabin floor.

FIG. 11 depicts an example of the interchangeable and reconfigurable floor mounting mechanism (7) being reconfigured for mounting the stretcher bridge (5) onto the cabin floor seat tracks (9) or the medical floor (27). This figure illustrates the use of the interchangeable and reconfigurable floor mounting mechanism (7) in use cases where the aircraft cabin may not have sufficient height clearance to accommodate the stretcher bridge (5) with attached medical equipment. The stretcher bridge (5) may be detached from the stretcher (4) and mounted on the cabin floor while keeping the medical equipment connected to the patient.

Upon unloading the stretcher (4) from the aircraft, the stretcher bridge (5) is detached from the cabin floor and reattached to the stretcher (4).

As depicted in FIG. 11, the stretcher bridge (5) is mounted on a stretcher bridge mounting frame (30) that is equipped with a mounting slot (31) that is compatible with an attachment (33) (which is often on the aft side) on the stretcher bridge (5), and a mounting point (32) that is compatible with the forward attachment (34) on the stretcher bridge (5). The stretcher bridge mounting frame (30) has load beam mounting holes (35) through which the load bearing beams (10) on the interchangeable and reconfigurable floor mounting mechanism (7) is inserted through. The stretcher bridge mounting frame (30) is secured in place on the interchangeable and reconfigurable floor mounting mechanism (7) by load bearing beam end caps (36) which is attached on both ends of the loading bearing beam (10). The attachment mechanism of the load bearing beam end caps (36) may be of any suitable type, for example threaded or otherwise.

FIG. 12 depicts an example of securing a litter (41) typified by a fabric (49) spanning between two parallel poles (48), to the aircraft cabin floor. The figure illustrates the use of the interchangeable and reconfigurable floor mounting mechanism (7) where the interchangeable and reconfigurable floor mounting mechanism may be configured with a cross body securing strap (42) that wraps around the outside of the litter poles (48) and is tightened using an adjustable buckle (43). By wrapping the cross body securing strap (42) around the litter poles (48) and over the patient lying on the litter and then tightening the strap, the litter (41) with the patient may be secured onto the aircraft cabin floor.

FIG. 13 depicts an alternate example of securing a litter (41) typified by a fabric (49) spanning between two parallel poles (48), to the aircraft cabin floor. The figure illustrates the use of the interchangeable and reconfigurable floor mounting mechanism (7) where the interchangeable and reconfigurable floor mounting mechanism may be configured with a cross body securing strap (42) that wraps around the outside of the litter poles (48) and tightened using an adjustable buckle (43). A patient shoulder harness (45) may be added to further restraint the patient in addition to the cross body securing strap (42). By wrapping the cross body securing strap (42) around the litter poles (48) and over the patient lying on the litter and then tightening the strap, the litter (41) with the patient may be secured onto the aircraft cabin floor. By looping the patient shoulder harness (45) over the patient's shoulders and connecting the patient shoulder harness to the adjustable buckle (43), a four-point harness restraint system can be created.

FIG. 14 depicts an example configuration of a litter (41) mounting system, by configuring the interchangeable and reconfigurable floor mounting mechanism into an alternate litter mount configuration. This litter (41) mounting system according to the invention uses cross body securing straps (42) that wrap around the parallel poles on the litter (48) and over the patient lying on the litter (41) to secure the litter (41) and patient onto the aircraft cabin floor. FIG. 14 illustrates one example embodiment of this litter (41) mounting scheme using the interchangeable and reconfigurable floor mounting mechanism (7). The basic interchangeable and reconfigurable floor mounting mechanism (7) may be reconfigured through the addition of a cross body securing strap mounts (44). The cross body securing strap mount (44) has two load beam mounting holes (15) through which the load bearing beams (10) are passed. The cross body securing strap mount (44) has a spring loaded pin (13) on each side, with pins that protrude into the load beam mounting holes (15). The spring loaded pin (13) may be retracted from the load beam mounting holes (11) by pulling on the ring mounted on its end to compress the internal spring. The end (25) of the spring loaded pin (13) extends into one of the load beam mounting holes (11) to secure the cross body securing strap mount (44) in place along the load bearing beams (10). The mount has two cross body securing straps (42) connected by a buckle (43) which may be released to disconnect the two securing straps (42). The buckle (43) has a mechanism that allows the length of the cross body securing straps to be adjusted by pulling or pushing on the ends of the strap (47).

FIG. 15 depicts an alternate configuration of a litter (41) mounting system, by configuring the interchangeable and reconfigurable floor mounting mechanism into an alternate litter mount configuration with shoulder straps. This litter (41) mounting system according to the invention adds a shoulder harness (45). The shoulder harness is connected to the horizontal strap (46) that can either wrap around the external parallel poles (48) but under the patient lying on the litter (41) to secure the litter (41) and patient onto the aircraft cabin floor; or be left under the litter (41) but the shoulder straps extended over the end of the litter fabric (49) and over the shoulders of the patient lying on the litter to connect to the buckle (43) on the cross body securing strap (42) to form a four-point harness restraint system. FIG. 15 illustrates one example embodiment of this litter (41) mounting scheme using the interchangeable and reconfigurable floor mounting mechanism (7). The basic interchangeable and reconfigurable floor mounting mechanism (7) may be reconfigured through the addition of the shoulder harness (45) connected to the horizontal strap onto the cross body securing strap mount (44). The horizontal strap (46) comprises of two parts connected by a buckle (43) which may be released. The horizontal strap (46) is looped over the parallel bars on the litter (41) but under the body of the patient lying down on the litter, or under the litter (41) and the shoulder harness (45) brought over the shoulders of the patient and onto the chest of the patient. The ends of the shoulder harness (45) is equipped with a buckle inset (47) that connects to the buckle (43) of the cross body securing strap to form a four-point harness restraint system for securing the patient.

FIG. 16 depicts an alternate example of securing a litter (41) typified by a fabric (49) spanning between two parallel poles (48), to the aircraft cabin floor using mechanical means. The litter (41) may be equipped with patient securing straps that are for example part of the litter (41) typified by a cross body strap (52) with a buckle (53). The figure illustrates the use of the interchangeable and reconfigurable floor mounting mechanism (7) where the interchangeable and reconfigurable floor mounting mechanism may be configured with a mechanical litter securing mechanism (50) that will mechanically fasten the litter (41) to the interchangeable and reconfigurable floor mounting mechanism. The patient is secured to the litter (41) only using the litter (41) cross body straps (52). The figure also depicts the containment tray (51) which may be installed under the litter (41) to contain biological fluids. The containment tray (51) will be a typical accessory that can be installed as part of the medical stretcher transfer system.

FIG. 17 depicts an alternate example of securing a litter (41) typified by a fabric (49) stretched between two parallel poles (48), to the aircraft cabin floor using mechanical means. The figure illustrates the use of the interchangeable and reconfigurable floor mounting mechanism (7) where the interchangeable and reconfigurable floor mounting mechanism may be configured with a mechanical litter securing mechanism (50) that will mechanically fasten the litter (41) to the interchangeable and reconfigurable floor mounting mechanism. The interchangeable and reconfigurable floor mounting mechanism may also be configured with cross body strap (42) equipped with a buckle (43) and a shoulder harness (45). The patient is secured to the litter (41) using the shoulder harness (45) and cross body straps (42). The figure also depicts the containment tray (51) which may be installed under the litter (41) to contain biological fluids. The containment tray (51) will be a typical accessory that can be installed as part of the medical stretcher transfer system.

FIG. 18 depicts an example configuration of a litter (41) mounting system, by configuring the interchangeable and reconfigurable floor mounting mechanism into an alternate mechanical litter mount configuration. This litter (41) mounting system according to the invention uses a combination of a fixed clasp (54) that secures one of the poles (48) on the litter (48) and a mechanically reversible clasp (57) to secure the other litter pole (48). FIG. 18 only illustrates one of the embodiments of this litter (41) mounting scheme using the interchangeable and reconfigurable floor mounting mechanism (7). The basic interchangeable and reconfigurable floor mounting mechanism (7) may be reconfigured through the addition of the fixed clasp mount (55) and the reversible clasp mount (56). The fixed clasp mount (55) and the reversible clasp mount (56) have two load beam mounting holes (15) through which the load bearing beams (10) are passed through. The fixed clasp mount (55) and reversible clasp mount (56) have a spring loaded pin (13) on each side, with pins that protrude into the load beam mounting holes (15). The spring loaded pin (13) may be retracted from the load beam mounting holes (11) by pulling on the ring mounted on its end to compress the internal spring.

The end (25) of the spring loaded pin (13) extends into one of the load beam mounting holes (11) to secure the fixed clasp mount (55) and reversible clasp mount (56) in place along the load bearing beams (10).

FIG. 19 depicts an example configuration of a litter (41) mounting system, by configuring the interchangeable and reconfigurable floor mounting mechanism into an alternate mechanical litter mount configuration with a cross body strap. This litter (41) mounting system according to the invention uses a combination of a fixed clasp (54) and mechanically reversible clasp (57). Each end of the cross body strap (42) are secured onto the fixed clasp mount (55) and the reversible clasp mount (56) respectively. The cross body strap (42) comprises of two parts joined by a buckle (43) and the strap may be tightened or loosened by adjust end the ends of the strap (47) along the buckle. The shoulder harness (45) may be substituted for the cross body strap (42) as an alternate configuration.

FIG. 20 depicts an alternate example configuration of a litter (41) mounting system, by configuring the interchangeable and reconfigurable floor mounting mechanism into an alternate mechanical litter mount configuration. This litter (41) mounting system according to the invention two mechanically reversible clasps (57) to secure each of the litter poles (48). FIG. 20 only illustrates one of the embodiments of this litter (41) mounting scheme using the interchangeable and reconfigurable floor mounting mechanism (7). The basic interchangeable and reconfigurable floor mounting mechanism (7) may be reconfigured through the addition of two reversible clasp mounts (56).

FIG. 21 depicts a generic example of a dual stretcher mount accessory that may be mounted onto the interchangeable and reconfigurable floor mounting mechanism (61). The dual stretcher mount comprises a vertical support mechanism (60) upon which the lower stretcher mount (59) and the upper stretcher mount (58) may be installed. Both the lower stretcher mount (59) and upper stretcher mount (58) may be configured to mount a litter (41) or the aviation stretcher (4) according to the invention.

FIG. 22 depicts an alternate implementation of a stretcher bridge according to the invention (5), comprising a two part mounting frame (62). Each part is equipped with a clasp that clamps onto the stretcher (4) frame. A mounting tray (63) can be mounted onto of the mounting frame (62). The mounting tray (63) is equipped with a patterned arrangement of mounting slots (66) to which equipment mounting poles (64) or various other implementations may be secured. The equipment mounting poles (64) can be fitted onto the mounting tray (63) using the mounting slots (66).

FIG. 23 depicts an example implementation to secure the stretcher bridge (5) as described in FIG. 22 onto stretcher (4).

The use of the interchangeable and reconfigurable floor mounting mechanism (7) according to the invention allows medical accessories, litters and the stretcher according to the invention to be mounted on the cabin floor. The use of a mounting frame of which the stretcher bridge mounting frame (30) and medical accessory mounting frame (23) are examples and illustrative of, exemplifies the concept of the mounting mechanism according to the invention. The mounting mechanism according to the invention allows the stretchers and medical accessories to be mounted in any location on the cabin floor and arranged in any layout as required as long as there are seat tracks (9).

By reconfiguring the interchangeable and reconfigurable floor mounting mechanism (7), the basic mechanism may be adapted into alternate configurations (6) for mounting stretchers or aeromedical evacuation accessories (8) and dual stretcher mount accessory. The design of the interchangeable and reconfiguration floor mounting mechanism (7) and the use of seat track mounts (12) with seat track fittings (16) allows the stretcher system according to the invention to be installed onto any aircraft with compatible seat tracks (9) without first permanently the aircraft cabin. The use of the stretcher bridge (5) also allows life support equipment to be securely mounted and transferred between aircraft without the need for permanent cabin modifications for mounting such equipment, by keeping the equipment mounted on the stretcher bridge (5).

One alternative implementation of the interchangeable and reconfigurable floor mounting mechanism (7) comprises dedicated floor mounts for the stretcher (4) only, and floor mounts with seat track fittings (16) fitting directly onto the medical accessory mounting frame (30) of the different medical accessories exemplified by the oxygen bottle rack and stretcher bridge (5). This alternate implementation does not confer the same degree of flexibility but is considered an alternative.

Component and spare parts for the stretcher system according to the invention can be stored in a container or box. The stretcher system according to the invention can be reconfigured with the parts according to the user requirements and the aircraft type and model. The parts container may be stored or carried on board the aircraft.

The stretcher system according to the invention is designed to be reconfigurable by the user. The parts that are reconfigurable by the user require no maintenance actions by the user, and damaged or defective parts can be replaced individually and sent out to the user for field replacement. The stretcher (4) and stretcher bridge (5) according to the invention are designed to not require maintenance during operation apart from replacement of parts when the parts are worn or damaged. The stretcher system according to the invention may be maintained using disassembly and assembly instructions that are provided.

It is convenient to describe the invention herein in relation to particularly preferred embodiments relating to a helicopter. However, the invention is applicable to a wide range of aircraft including fixed wing aeroplanes, helicopters and road ambulances and it is to be appreciated that other constructions and arrangements are also considered as falling within the scope of the invention. Various modifications, alterations, variations and or additions to the construction and arrangements described herein are also considered as falling within the ambit and scope of the present invention.

What is claimed is:

1.-8. (canceled)

9. An apparatus for reversibly fixing a medical apparatus to a floor of a vehicle, the apparatus, comprising: a fitting to engage with the floor of the vehicle, and a support, wherein
the fitting comprises a mount for engagement with either a hard point fitting or a seat track fitting specific to a seat track type of the vehicle and thereby fixable and lockable to a hard point fitting or the seat track of the vehicle;
the support comprises a plurality of load bearing beams and means for reversible engagement with the medical apparatus
and the fitting is slidably adjustable relative to the support so as to enable reversible fixing of the apparatus to a plurality of vehicle configurations.

10. The apparatus as claimed in claim 1, wherein the seat track fitting is fixable to the floor of the vehicle either directly to the seat track, or by use of a medical floor with a seat track.

11. The apparatus as claimed in claim 1, wherein the means for reversible engagement with the medical apparatus is a reversible clasp.

12. The apparatus as claimed in claim 1, wherein the fitting is slidably adjustable along at least one load bearing beam.

13. The apparatus as claimed in claim 1, wherein the medical apparatus comprises one or more of a litter, a stretcher, a medical apparatus stand, and a stretcher bridge.

14. The apparatus according to claim 1, further comprising a guide for facilitating fixing of the medical apparatus to the vehicle and an inclined portion to guide the medical apparatus along a path directly away from a vehicle surface.

15. The apparatus according to claim 14, wherein the guide comprises a stretcher guide ramp.

16. The apparatus as claimed in claim 1, further comprising: two load bearing beams equipped with load beam mounting holes at varying distances and at least one seat track mounts, the load bearing beams passing through the load beam mounting holes in the seat track mounts, the seat track mounts comprising spring loaded pins that protrude into the load beam mounting holes, the pins being retractable from the load beam mounting holes and each pin extendable into the load beam mounting hole to secure the load bearing beam in place such that different pitch adjustments and seat track widths can be accommodated by varying the load beam mounting holes that the pins are inserted into and thereby adjusting seat track mounts along a length of the load bearing beam.

17. The apparatus as claimed in claim 1, wherein the support comprises a stretcher mount with a stretcher mounting pin hole so that a retractable stretcher mounting pin on a stretcher mounted stretcher mount latch may be inserted to securely lock the stretcher onto the stretcher mount.

18. The apparatus according to claim 1, further comprising: a stretcher glide ramp mounted over the load bearing beams to provide a glide surface for a stretcher to slide along until it can be latched in place on a stretcher mount and a retractable stretcher mount pin is extended to engage with a stretcher mount pin hole.

19. The apparatus as claimed in claim 1, comprising one or more of: a cross body securing strap; a patient shoulder harness; a horizontal strap; a containment tray; a fixed clasp; a mechanically reversible clasp; a mounting tray; and an equipment mounting pole, each together with associated mount(s).
